(19) United States
(12) Patent Application Publication
(10) Pub. No.: US 2015/0355916 A1
(43) Pub. Date: Dec. 10, 2015

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: Go Inoue, Abiko-shi (JP)

(21) Appl. No.: 14/726,980

(22) Filed: Jun. 1, 2015

(30) Foreign Application Priority Data
Jun. 9, 2014 (JP) 2014-119108

(51) Int. Cl. G06F 9/445; H04N 1/00

(52) U.S. Cl. CPC G06F 9/44505; H04N 1/00413; H04N 1/00474; H04N 2201/0094

(57) ABSTRACT

An information processing apparatus of the present invention reflects setting changes using a first-type setting that does not require an additional user operation for reflecting a setting change in the information processing apparatus, a second-type setting that requires the additional user operation for reflecting a setting change in the information processing apparatus and does not require restarting the information processing apparatus, and a third-type setting that requires both the additional user operation and restarting the information processing apparatus for reflecting a setting change in the information processing apparatus.

### BACKGROUND OF THE INVENTION

1. Field of the Invention

The present invention relates to an information processing apparatus, a method for controlling the same, and a storage medium.

2. Description of the Related Art

In an information device loaded with various applications, settings of each application are designed to be made or to be changed by a user via a screen operation unit. The user changes the settings of the application to arbitrary values in this way, thereby enabling the application to be executed with a behavior desired by the user.

The setting items of such settings include setting items that are immediately reflected in the behavior of the application upon a change, and setting items that are not reflected until the user performs a specific reflection operation. The former setting items are realized by immediately executing, upon detection of a setting change by the application, processing in which the setting is reflected, or referring to the setting every time the application executes processing. In the case of the latter setting items, a setting change is reflected, for example, by restarting the information device, or a user operation for reflecting the setting via an operation screen causes processing in which the setting is reflected to start. The latter setting items are employed in the case where there is a fear that mismatch, overlapping processing, or the like occurs in the behavior of the application if the setting is reflected immediately when changed. For example, Japanese Patent Laid-Open No. 2005-309567 describes processing for collectively reflecting settings, as an operation to reflect the settings.

However, in the case where setting items whose settings are immediately reflected and setting items that require a specific operation to reflect their settings are mixed, it is difficult for the user to know whether or not a setting change made by the user has been reflected in the behavior of the device. This may induce an erroneous user operation. For example, in the case where the user has changed a setting of the setting items that require a specific operation to reflect their settings, a situation in which results expected by the user cannot be obtained occurs when the user executes the application while mistakenly thinking that the setting change has been immediately reflected in the behavior.

Further, in the case where a plurality of users such as an administrator and general users can operate the settings of the device, it is probable that a user changes a setting and leaves the device without reflecting the setting in the behavior of the device. In such a case, it is also probable, when another user operates the device, that the other user operates the device without recognizing that the setting and the behavior of the device do not match each other, believing that the setting has been reflected in the behavior of the device. In this case as well, results expected by the user cannot be obtained. Further, in the case where there are a plurality of operation methods such as a restart operation and a collective reflection operation as operation methods other than the operation method in which settings are immediately reflected, there is a problem that it is confusing for the user to determine which operation should be performed, after the user has changed a setting, for reflecting the changed setting in the device.

### SUMMARY OF THE INVENTION

The present invention enables realization of a mechanism that allows a user, when a setting of a function is changed, to easily reflect the setting change, even in the case where there are a plurality of approaches to reflect the setting change. One aspect of the present invention provides

One aspect of the present invention provides an information processing apparatus having a first-type setting that does not require an additional user operation for reflecting a setting change in the information processing apparatus, a second-type setting that requires the additional user operation for reflecting a setting change in the information processing apparatus and does not require restarting the information processing apparatus, and a third-type setting that requires both the additional user operation and restarting the information processing apparatus for reflecting a setting change in the information processing apparatus, the information processing apparatus comprising: a determination unit configured to determine, in a case where a setting of the information processing apparatus is changed by a user, whether or not the additional user operation is required for reflecting the setting change in the information processing apparatus; a display unit configured to display a reflection button that allows the user to issue an instruction to reflect the setting change in the information processing apparatus, in a case where the determination unit determined that the additional operation is required; a reflection unit configured to reflect the setting change in the information processing apparatus when the reflection button is operated by the user; and a notification unit configured to notify the user that restarting the information processing apparatus is required, in a case where the setting changed by the user is the third-type setting, wherein the determination unit determines that the additional operation is not required in a case where the setting changed by the user is the first-type setting, the determination unit determines that the additional operation is required in a case where the setting changed by the user is the second-type setting or the third-type setting, in a case where the determination unit determined that the additional operation is not required, the reflection unit reflects the setting change in the information processing apparatus without the display unit displaying the reflection button, in a case where the reflection button is operated by the user, and the setting changed by the user is the second-type setting, the reflection unit reflects the setting change in the information processing apparatus without restarting the information processing apparatus, in a case where the reflection button is operated by the user, and the setting changed by the user is the third-type setting, the reflection unit reflects the setting change in the information processing apparatus by restarting the information processing apparatus, and the reflection button is a button for collectively reflecting a plurality of setting changes in the information processing apparatus.

Another aspect of the present invention provides a method for controlling an information processing apparatus having a first-type setting that does not require an additional user operation for reflecting a setting change in the information processing apparatus, a second-type setting that requires the additional user operation for reflecting a setting change in the information processing apparatus and does not require restarting the information processing apparatus, and a third-type setting that requires both the additional user operation and restarting the information processing apparatus for reflecting a setting change in the information processing apparatus, the method comprising: determining, in a case where a setting of the information processing apparatus is changed by a user, whether or not the additional user operation is required for reflecting the setting change in the information processing apparatus; displaying, on a display unit, a reflection button that allows the user to issue an instruction to reflect the setting change in the information processing apparatus, in a case where it is determined in the determination step that the additional operation is required; reflecting the setting change in the information processing apparatus when the reflection button is operated by the user; and notifying the user that restarting the information processing apparatus is required, in a case where the setting changed by the user is the third-type setting, wherein it is determined in the determination step that the additional operation is not required in a case where the setting changed by the user is the first-type setting, it is determined in the determination step that the additional operation is required in a case where the setting changed by the user is the second-type setting or the third-type setting, in a case where it is determined in the determination step that the additional operation is not required, the setting change is reflected in the information processing apparatus in the reflection step without the display unit displaying the reflection button, in a case where the reflection button is operated by the user, and the setting changed by the user is the second-type setting, the setting change is reflected in the information processing apparatus in the reflection step without restarting the information processing apparatus, in a case where the reflection button is operated by the user, and the setting changed by the user is the third-type setting, the setting change is reflected in the information processing apparatus in the reflection step by restarting the information processing apparatus, and the reflection button is a button for collectively reflecting a plurality of setting changes in the information processing apparatus.

Still another aspect of the present invention provides a non-transitory computer-readable storage medium storing a computer program for causing a computer to execute a method for controlling an information processing apparatus having a first-type setting that does not require an additional user operation for reflecting a setting change in the information processing apparatus, a second-type setting that requires the additional user operation for reflecting a setting change in the information processing apparatus and does not require restarting the information processing apparatus, and a third-type setting that requires both the additional user operation and restarting the information processing apparatus for reflecting a setting change in the information processing apparatus, the program comprising: determining, in a case where a setting of the information processing apparatus is changed by a user, whether or not the additional user operation is required for reflecting the setting change in the information processing apparatus; displaying, on a display unit, a reflection button that allows the user to issue an instruction to reflect the setting change in the information processing apparatus, in a case where it is determined in the determination step that the additional operation is required; reflecting the setting change in the information processing apparatus when the reflection button is operated by the user; and notifying the user that restarting the information processing apparatus is required in a case where the setting changed by the user is the third-type setting, wherein it is determined in the determination step that the additional operation is not required in a case where the setting changed by the user is the first-type setting, it is determined in the determination step that the additional operation is required in a case where the setting changed by the user is the second-type setting or the third-type setting, in a case where it is determined in the determination step that the additional operation is not required, the setting change is reflected in the information processing apparatus in the reflection step without the display unit displaying the reflection button, in a case where the reflection button is operated by the user, and the setting changed by the user is the second-type setting, the setting change is reflected in the information processing apparatus in the reflection step without restarting the information processing apparatus, in a case where the reflection button is operated by the user, and the setting changed by the user is the third-type setting, the setting change is reflected in the information processing apparatus in the reflection step by restarting the information processing apparatus, and the reflection button is a button for collectively reflecting a plurality of setting changes in the information processing apparatus.

Further features of the present invention will be apparent from the following description of exemplary embodiments with reference to the attached drawings.

### BRIEF DESCRIPTION OF THE DRAWINGS

FIG. 1 is a diagram illustrating a network configuration according to the present embodiment.

FIG. 2 is a block diagram showing a hardware configuration of a printing apparatus according to Embodiment 1.

FIG. 3 is a diagram illustrating a configuration of screens to be displayed on an operation panel of the printing apparatus according to Embodiment 1.

FIG. 4 is a view showing an example of an operation screen, which is an example of a function screen according to Embodiment 1, displayed by a copy application.

FIG. 5 is a functional block diagram illustrating a software configuration of the printing apparatus according to Embodiment 1.

FIG. 6 is a view showing an example of an operation screen when settings have been changed at the time of execution of the copy application, but have not been reflected in the printing apparatus according to Embodiment 1.

FIG. 7 is a table showing an example of a setting type list that defines the method for reflecting a setting change for each setting item in the printing apparatus according to Embodiment 1.

FIG. 8 is a flowchart illustrating processing for switching a screen display at the time of a setting change in the printing apparatus according to Embodiment 1 of the present invention.

FIG. 9 is a flowchart illustrating a behavior of the printing apparatus in the case where a user performs an operation to reflect settings in the printing apparatus according to Embodiment 1.

FIG. 10A and FIG. 10B are views showing examples of screens for reflecting a setting change in the printing apparatus according to Embodiment 1.

FIG. 11A and FIG. 11B are views showing examples of screens for making settings of copying in the printing apparatus according to Embodiment 1.

FIG. 12A and FIG. 12B are views showing examples of operation screens, which are displayed on an operation panel of a printing apparatus according to Embodiment 2 of the present invention, for issuing an instruction to reflect settings.

FIG. 13 is a view showing an example of a screen to be displayed in the case where there are no changed settings to be reflected, when an instruction to reflect settings is issued via the screen of Embodiment 2.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

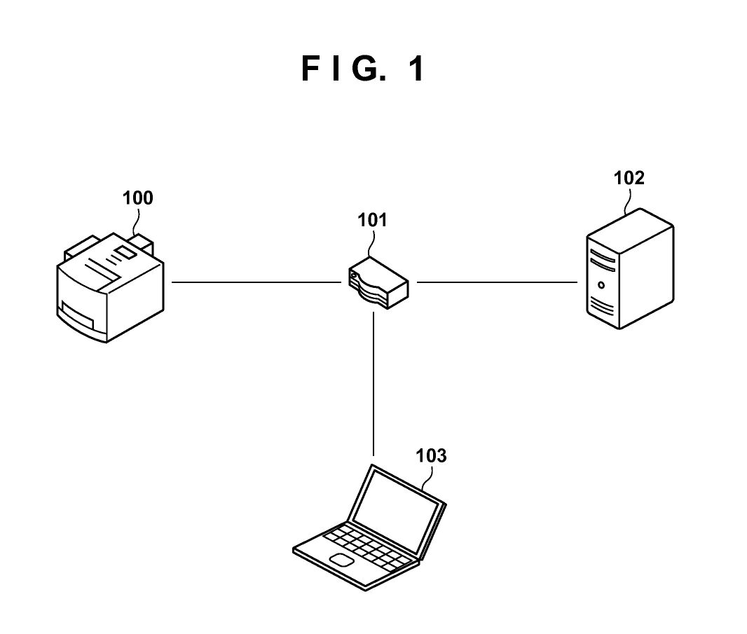

FIG. 1 is a diagram illustrating a network configuration according to the present embodiment.

A printing apparatus 100 is connected to various servers 102 and various information terminals 103 via a gateway 101. Although FIG. 1 shows the case where the network is a wired IP network, the network may be a wireless IP network. In the embodiments described below, a printing apparatus is described as an example of the information processing apparatus of the present invention, but the present invention is not limited to such a printing apparatus.

### Embodiment 1

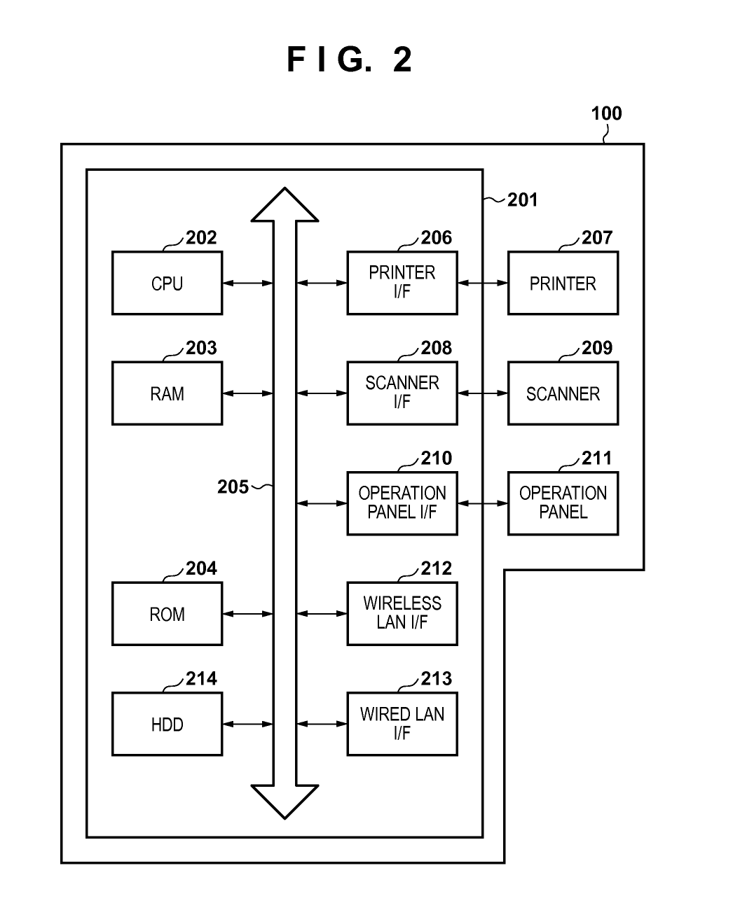

FIG. 2 is a block diagram showing a hardware configuration of the printing apparatus 100 according to Embodiment 1. The printing apparatus 100 described herein is a multi-function peripheral that includes a scanner and the like, and that can perform a plurality of functions, but may be a printing apparatus having only a printing function.

A control unit 201 including a CPU 202 controls the overall behavior of the printing apparatus 100. The CPU 202 performs various controls such as printing control and communication control by reading control programs stored in a ROM 204. A RAM 203 is used as a temporary storage region such as a work area and a main memory of the CPU 202. An HDD 214 stores data, various programs, various information tables, or the like. A printer I/F 206 serves as an interface for outputting image signals to a printer 207 (printer engine). A scanner I/F 208 serves as an interface for receiving image signals from a scanner 209 (scanner engine). The CPU 202 processes the image signals input through the scanner I/F 208, and outputs them as recording image signals to the printer I/F 206, thereby executing copying. An operation panel I/F 210 connects an operation panel 211 and the control unit 201 to each other. The operation panel 211 includes a keyboard, a display unit having a touch panel function, and the like. A wireless LAN I/F 212 wirelessly transmits information to external terminals such as mobile terminals, and receives various information from the external terminals. A wired LAN I/F 213 transmits information to external terminals such as mobile terminals, and receives various information from the external terminals, via a wired LAN. A system bus 205 connects the CPU 202 to the RAM 203, the ROM 204, the HDD 214, and the aforementioned interfaces 206, 208, 210, 212, and 213, so as to transmit data signals, control signals, and the like.

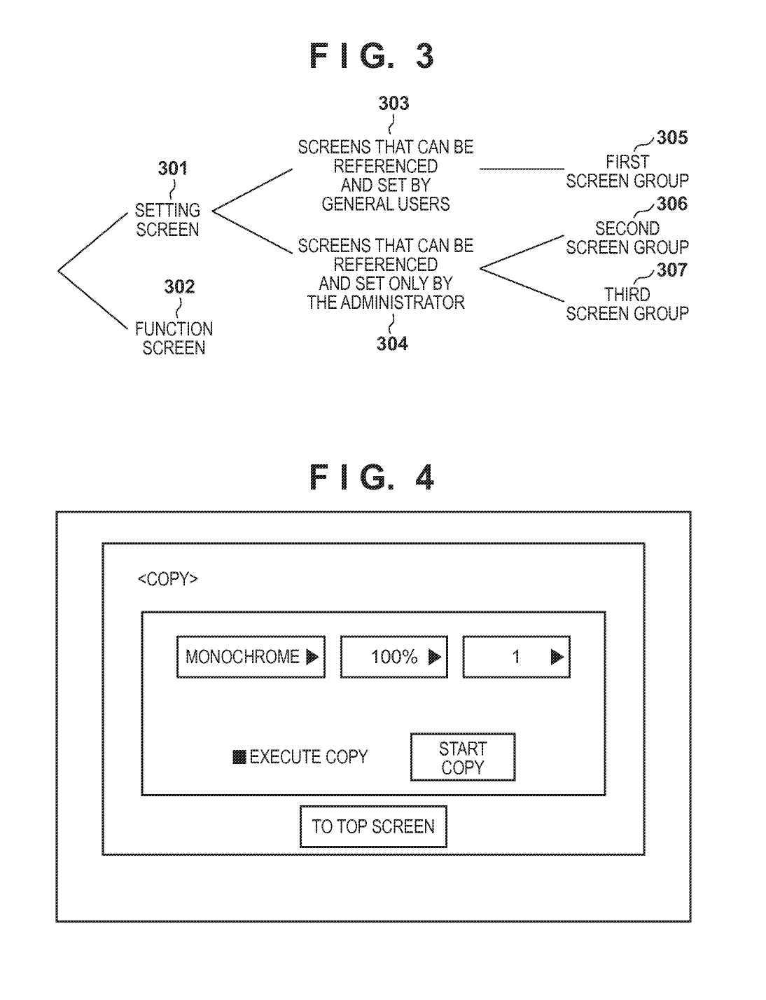

FIG. 3 is a diagram illustrating a configuration of screens to be displayed on the operation panel 211 of the printing apparatus 100 according to Embodiment 1.

The screens displayed on the printing apparatus 100 include a setting screen 301 for changing settings and a function screen 302 for operating the processing of each application. Further, the setting screen 301 includes a screen 303 that even general users can reference and make settings on, and a screen 304 that only the administrator of the printing apparatus 100 can reference and make settings on. Further, the setting screen 301 includes a first screen group 305 including setting items (types) whose setting change is immediately reflected by an operation to change the settings, a second screen group 306 including setting items that require a synchronization operation to reflect their settings, and a third screen group 307 including setting items that require a restart. Generally, the administrator can reference any screen and change the settings, whereas the capability of a general user is limited to referencing and making settings on only the first screen group 305 whose setting change is immediately reflected. It should be noted that the “setting change” means that settings after being changed are enabled in the printing apparatus 100, in other words, the settings after being changed are actually used as the settings of the printing apparatus 100 (applied to the printing apparatus 100).

The function screen 302 is an operation screen for performing functions of applications, for example, as shown in FIG. 4. On this screen, settings of applications cannot be changed, and the screen can be operated by both the administrator and a general user.

FIG. 4 is a view showing an example of an operation screen, which is an example of a function screen according to Embodiment 1, displayed by a copy application.

An instruction to make one monochrome copy at actual size is issued herein, and copying is started when the “COPY start” button is pressed in this state.

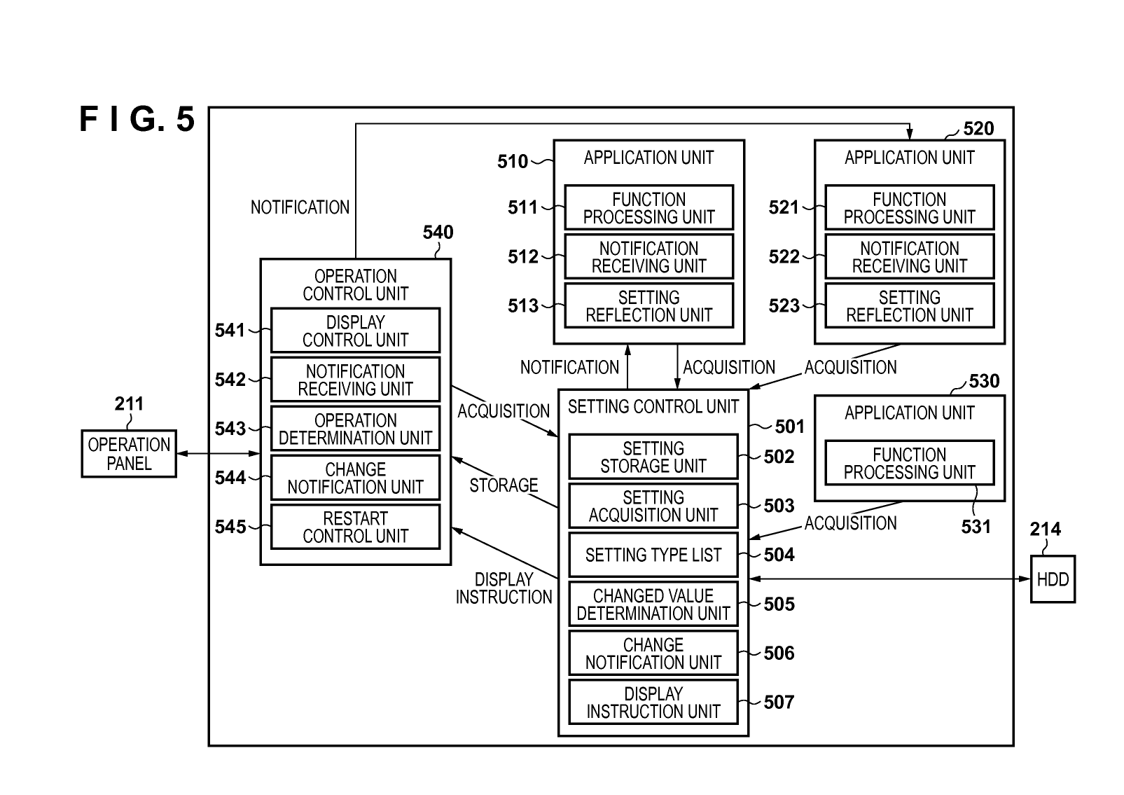

FIG. 5 is a functional block diagram illustrating a software configuration of the printing apparatus 100 according to Embodiment 1. Each functional unit shown in FIG. 5 is realized by the CPU 202 included in the printing apparatus 100 executing a control program stored in the ROM 204.

A setting control unit 501 includes a setting storage unit 502, a setting acquisition unit 503, a setting type list 504, which will be described below with reference to FIG. 7, a changed value determination unit 505, a change notification unit 506, and a display instruction unit 507. Upon acceptance of an operation to make or change settings on a predetermined function by a user via an operation screen, the setting control unit 501 executes processing such as acquiring the set contents or changed contents and notifying other functional blocks, and storing the settings in the HDD 214. The setting storage unit 502 and the setting acquisition unit 503 execute processing for reading the settings from the HDD 214 and writing settings to the HDD 214, in accordance with an instruction from an operation control unit 540 or application units. The setting type list 504 manages how the setting items of the printing apparatus 100 are reflected, such as being immediately reflected, being collectively reflected by a setting reflection button, or being reflected by a restart, for example, as shown in FIG. 7. The collective reflection herein means that, when there are a plurality of changed settings, the plurality of changed settings are collectively reflected.

FIG. 7 is a table showing an example of the setting type list 504 that defines the method (or approach or timing) for reflecting a setting change for each setting item in the printing apparatus 100 according to Embodiment 1. The setting type list 504 is stored in the HDD 214.

According to FIG. 7, it can be seen that the value of a density setting of the scanner 209 is, for example, reflected by restarting the printing apparatus 100, and the page fitting in copying is reflected in the processing of the copy application immediately when the setting is changed by a user via an operation screen. Further, in the case of DHCP and 802.1X, a setting change is reflected by an operation of the setting reflection button displayed on the operation panel 211, or restarting the printing apparatus 100.

The changed value determination unit 505 references the setting type list 504 when a setting is changed, and determines how the changed setting is reflected depending on the subject setting item. The change notification unit 506 notifies a registered application unit when a setting is changed and reflected. The display instruction unit 507 issues an instruction to display a screen following the setting change to the operation control unit 540.

An application unit 510 includes a function processing unit 511, a notification receiving unit 512, and a setting reflection unit 513. The application unit 510 is an application including the first screen group 305 such as a copy application. The function processing unit 511 processes functions of the application. For example, in the case of the copy application, a control for executing copying is performed. The notification receiving unit 512 receives a notification of a setting change in setting items of the application from the setting control unit 501. After the notification receiving unit 512 receives a change notification, the setting reflection unit 513 reflects the setting in the behavior of the application.

Similarly, an application unit 520 includes a function processing unit 521, a notification receiving unit 522, and a setting reflection unit 523. The application unit 520 is an application including the second screen group 306 for network-related applications such as DHCP and 802.1X. The function processing unit 521 processes functions of this application. For example, a DHCP application exchanges data with a DHCP server to obtain information such as an IP address and set it in the printing apparatus 100. The notification receiving unit 522 receives, from the operation control unit 540, an operation notification of the setting reflection button to issue an instruction of reflection of a setting. When the notification receiving unit 522 receives an instruction to reflect the setting change, the setting reflection unit 523 reflects the setting in the behavior of the application.

An application unit 530 includes a function processing unit 531. The application unit 530 is an application including the third screen group 307 whose settings are reflected by a restart, such as an application that uses the scanner 209. The function processing unit 531 executes functions of the application. For example, an application for adjusting the scanner 209 adjusts the density or the like of the scanner 209.

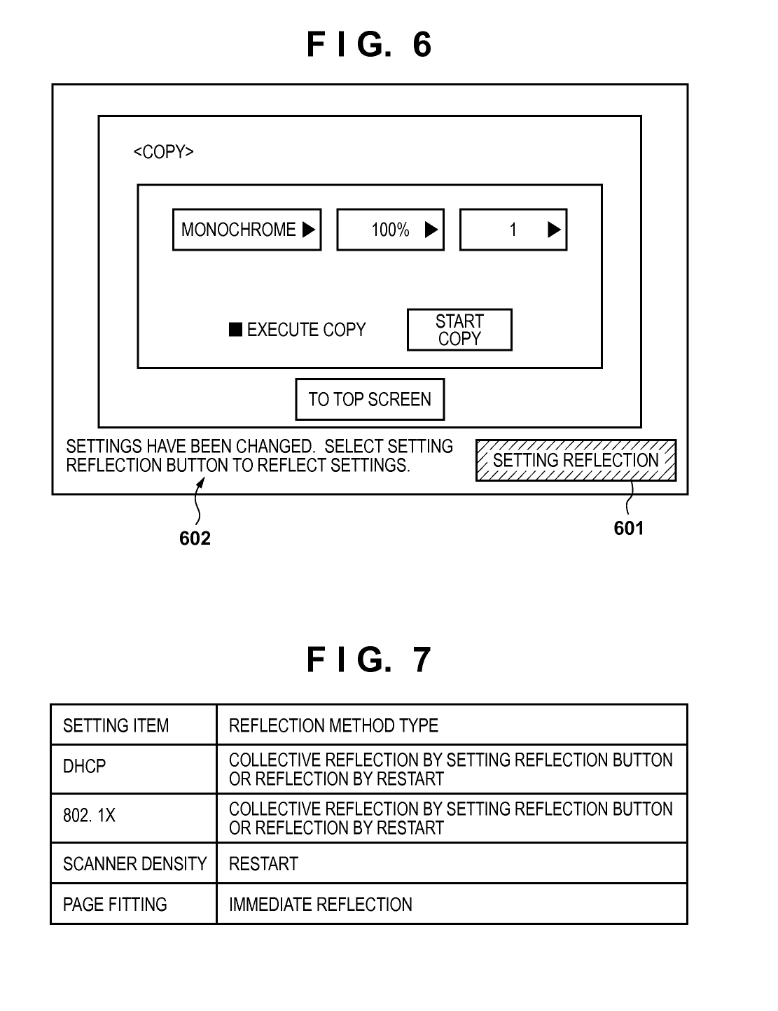

The operation control unit 540 includes a display control unit 541, a notification receiving unit 542, an operation determination unit 543, a change notification unit 544, and a restart control unit 545. The operation control unit 540 receives a user operation via a restart button of the operation panel 211, and notifies the application of the content or issues an instruction on the behavior of the printing apparatus 100. Further, the operation control unit 540, for example, performs the display control of the operation panel 211 in accordance with an instruction from the application. The display control unit 541 displays a screen on the operation panel 211 via the operation panel IF 210, and obtains settings or instructions input by the user and exchanges them with the setting control unit 501 or application units. The notification receiving unit 542 receives a notification of the presence or absence of a setting change or the like from the setting control unit 501, and displays a screen of a change notification or a setting reflection button, for example, as shown in FIG. 6, via the display control unit 541.

FIG. 6 is a view showing an example of an operation screen when settings have been changed at the time of execution of the copy application, but have not been reflected in the printing apparatus 100 according to Embodiment 1. A message 602 indicating that the settings have been changed and a setting reflection button 601 for reflecting the setting change in processing are displayed in addition to the function screen shown in FIG. 4. In this way, although settings of the application normally cannot be changed on the function screen, the function screen notifies the user that the settings have been changed at the time of execution of the copy application, and the settings are not yet reflected.

The operation determination unit 543 determines whether to restart the printing apparatus 100 or execute collective reflection processing, for example, on the condition that the setting reflection button 601 is pressed on the screen in FIG. 6. The change notification unit 544 notifies application units of the event in which the setting reflection button 601 was pressed. The restart control unit 545 restarts the printing apparatus 100.

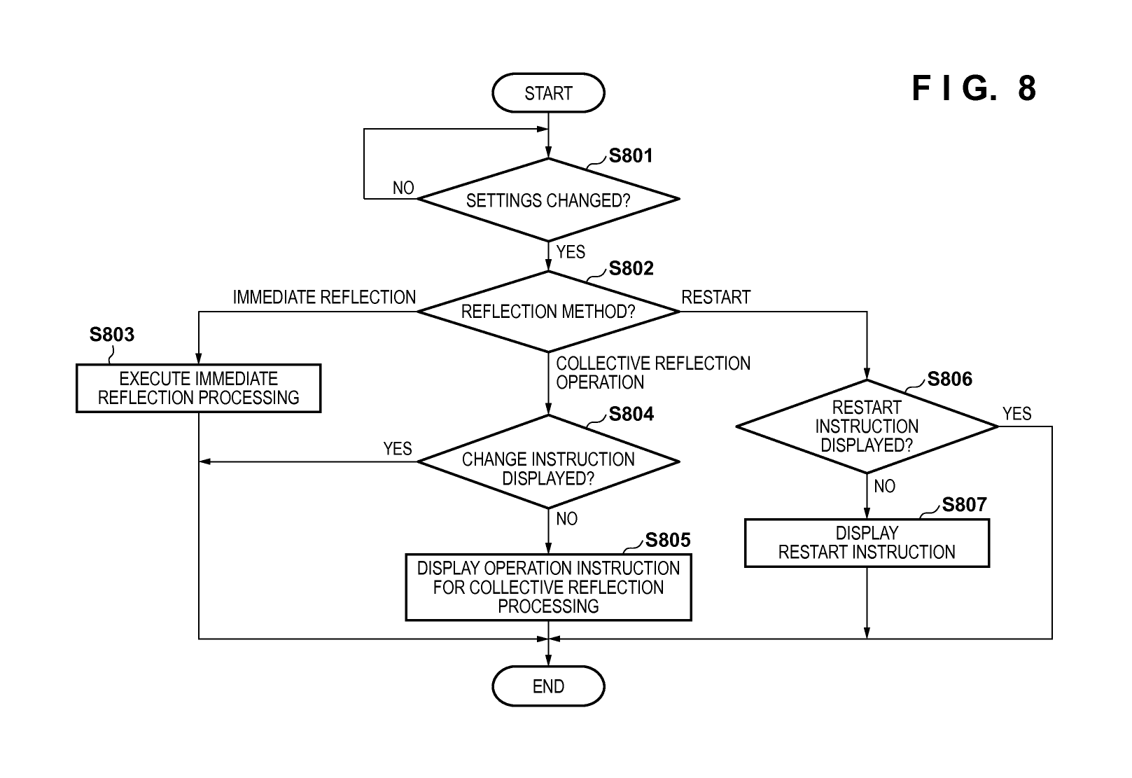

FIG. 8 is a flowchart illustrating processing for switching the screen display at the time of a setting change in the printing apparatus 100 according to Embodiment 1 of the present invention. Steps S801 to S807 indicate steps of the processing, a program showing a control procedure corresponding to each of the steps is stored in the ROM 204 of the printing apparatus 100, and the CPU 202 executes the program so as to perform the processing shown by this flowchart.

First, the CPU 202 waits for an event of a setting change by a user via the operation panel 211 in step S801. When a setting is changed, the CPU 202 stores the changed setting in the RAM 203 or the HDD 214. Next, the process proceeds to step S802, and the CPU 202 references the setting type list 504 shown in FIG. 7, and determines the setting reflection method of the setting item of the changed setting. Here, in the case where it is determined that the setting item of the changed setting is to be immediately reflected as in the case of the first screen group 305, the process proceeds to step S803, and the CPU 202 notifies the application that the setting has been changed. Upon receiving this notification, the application references the changed setting, reflects it in the behavior of the application, and ends this process.

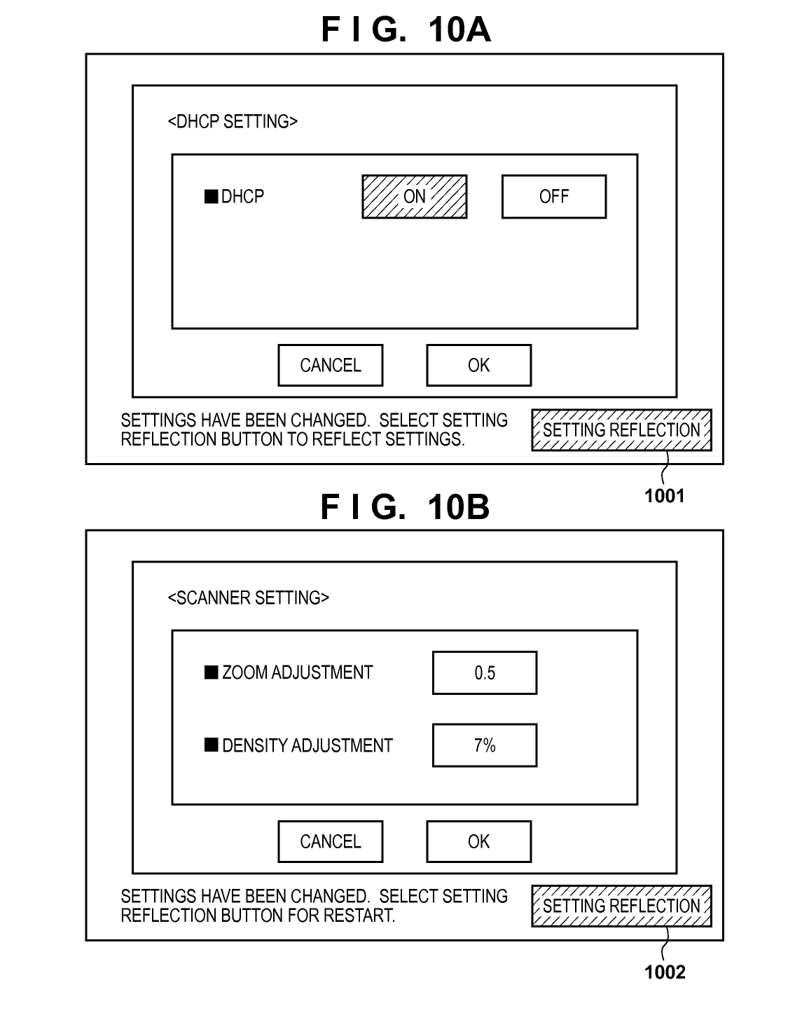

On the other hand, in the case where the CPU 202 determines that the setting item of the changed setting is to be reflected by a collective reflection operation or the like as in the case of the second screen group 306 in step S802, the process proceeds to step S804. The CPU 202 determines whether or not a change notification screen is displayed on the operation panel 211 at that time in step S804. The change notification screen is, for example, a screen for starting collective reflection processing upon selection of a setting reflection button 1001, as shown in FIG. 10A, or a screen displaying a notification that the printing apparatus 100 will be restarted upon selection of a setting reflection button 1002, as shown in FIG. 10B.

FIG. 10A and FIG. 10B are views showing examples of screens for reflecting the setting change in the printing apparatus 100 according to Embodiment 1.

FIG. 10A shows an example of a screen for reflecting the setting change in the case of the setting item being DHCP, and the setting “ON” of DHCP is reflected when the setting reflection button 1001 is pressed on this screen. In this way, in FIG. 10A, a message to prompt the user to perform a reflection operation to reflect the setting after being changed in the printing apparatus 100 is displayed together with the setting reflection button 1001. Further, FIG. 10B shows an example of a screen for reflecting the setting change in the case of the setting item being the scanner density. The printing apparatus 100 is restarted when the setting reflection button 1002 is pressed on this screen, and the changed setting of the scanner such as zoom adjustment and density adjustment is reflected in the scanner application. In the case where both a setting item for which the user is prompted to perform a reflection operation to reflect the setting after being changed in the printing apparatus 100 and a setting item for which the setting after being changed is reflected by restarting the printing apparatus 100 are changed, an instruction to restart the printing apparatus 100 is issued.

When the CPU 202 determines that neither of the screens of FIG. 10A and FIG. 10B is displayed in step S804, the process proceeds to step S805, and the CPU 202 controls the screen, for example, to display the message on the screen in FIG. 10A and the setting reflection button 1001. For example, this message is: “Settings have been changed. Select the setting reflection button to reflect the settings”. When the CPU 202 determines that either one of the screens is displayed in step S804, there is no need to display a notification screen again, and therefore the process ends.

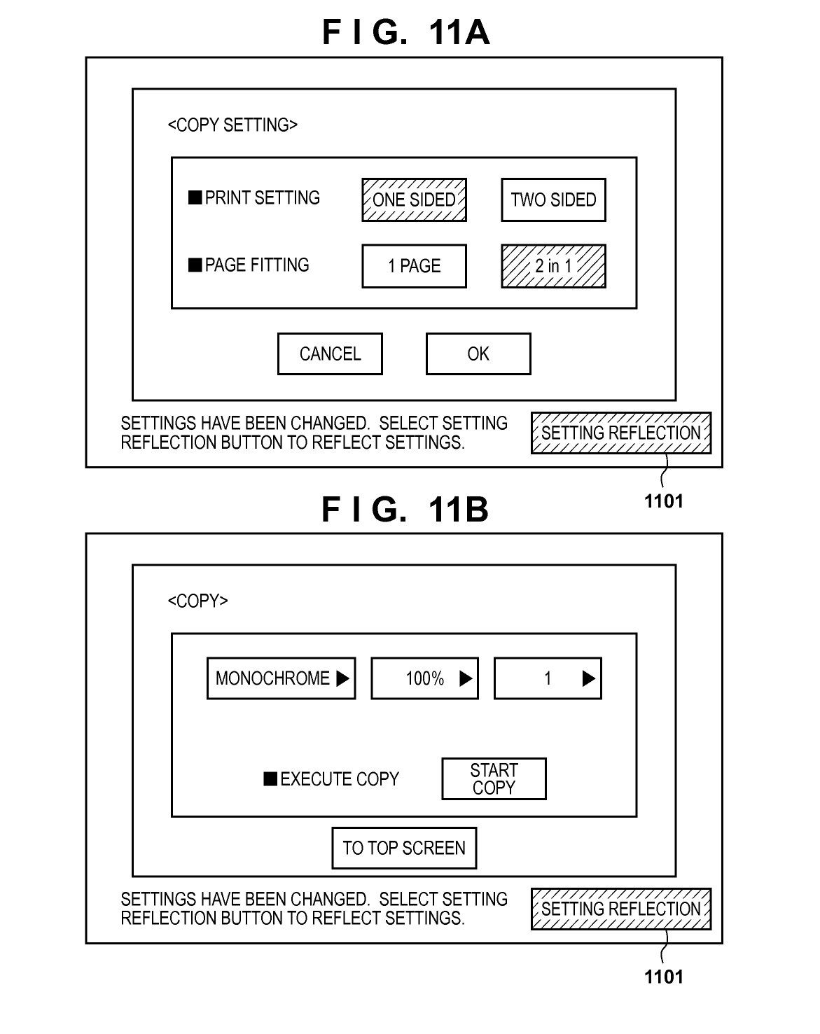

The message and the button on the screens shown in FIG. 10A and FIG. 10B notify the user that a mismatch exists between the changed settings and the behavior of the application due to a setting change, so that the screens prompt the user to reflect the changed settings. The message to prompt the user to reflect the settings and the setting reflection button are always displayed, for example, on the function screens shown in FIG. 11A and FIG. 11B and screens that a general user can reference, until the changed settings are reflected.

FIG. 11A and FIG. 11B are views showing examples of screens for making settings of copying in the printing apparatus 100 according to Embodiment 1. FIG. 11A shows an example of a screen for setting page fitting such as two-sided or one-sided printing and 2 in 1 in copy settings. FIG. 11B shows an example of a screen for setting monochrome printing, actual size, one copy, or the like on a function screen of copying and issuing an instruction to start copying. In FIG. 11A and FIG. 11B, the changed settings are not yet reflected, and therefore a message to prompt the user to reflect the settings and a setting reflection button 1101 are still displayed even if the screen has been switched. This enables users other than the user who has changed the settings to recognize that the settings have been changed, but not yet reflected. Further, the settings can be reflected by pressing the setting reflection button 1101 on any screen, and therefore the user operability can be enhanced. It should be noted that the message and the setting reflection button 1101 displayed on the screen are cleared by an operation to reflect the changed settings.

In the case where the CPU 202 determines that the setting item of the changed setting is reflected by a restart as in the case of the third screen group 307 in step S802, the process proceeds to step S806. In step S806, the CPU 202 determines whether or not the message to prompt the user to perform a restart and the button, as shown in FIG. 10B, are displayed on the operation panel 211 at that time. In the case where the message to prompt the user to perform a restart and the button are displayed, there is no need to display the message and the button again, and therefore this process ends. On the other hand, in the case where the CPU 202 determines that the message and the button are not displayed in step S806, the process proceeds to step S807, and the CPU 202 displays a screen including a message to prompt the user to perform a restart and the setting reflection button 1002, for example, as shown in FIG. 10B. Even if the message and the button, for example, as shown in FIG. 10A, are displayed in step S806, a message to instruct the user to perform a restart and the setting reflection button 1002 are displayed because the restart is needed as long as at least one item that requires a restart is included.

According to the flowchart of FIG. 8 in Embodiment 1, in the case where a setting has been changed, but the setting is not reflected, a screen for prompting the user to reflect the setting can be displayed in accordance with the setting reflection method set in advance for the setting item of the changed setting. Further, as long as the setting is not reflected, a message to prompt the user to make the reflection and an operation button are continuously displayed on function screens and operation screens, thereby allowing the user to recognize that the setting has not been reflected. When a user operation to change the setting is accepted, processing for reflecting the setting after being changed can be determined depending on the type of the changed setting.

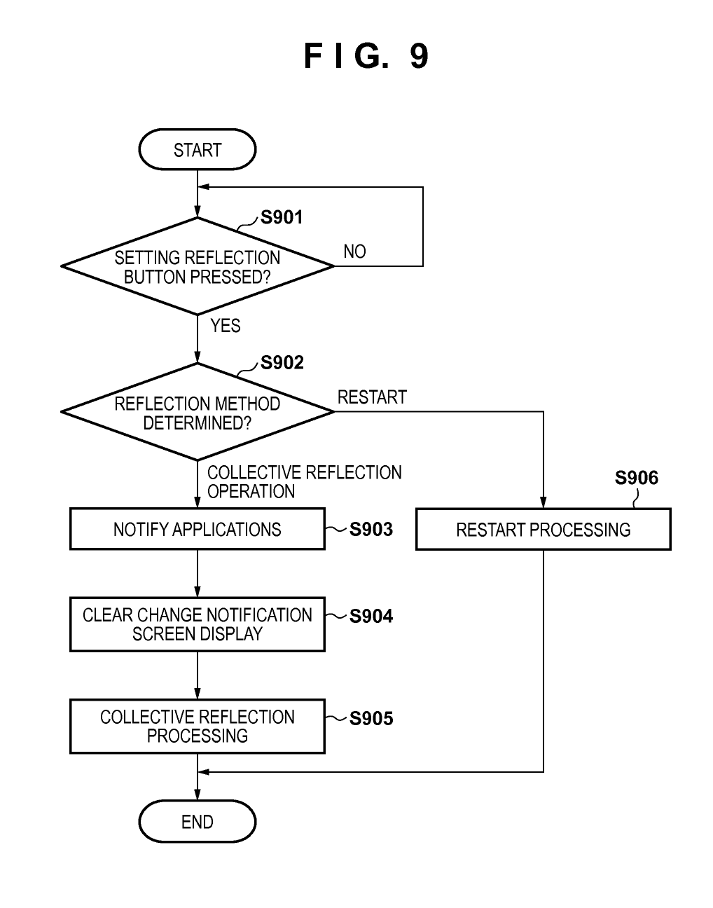

FIG. 9 is a flowchart illustrating a behavior of the printing apparatus 100 in the case where a user performs an operation to reflect a setting in the printing apparatus 100 according to Embodiment 1. Step S901 to step S906 indicate the processing steps, a program showing a control procedure corresponding to each of the steps is stored in the ROM 204 of the printing apparatus 100, and the CPU 202 executes the program so as to perform the processing shown by this flowchart.

First, the CPU 202 determines whether or not a setting reflection button was pressed on the operation panel 211 in step S901. When it is determined that the setting reflection button was pressed in step S901, the process proceeds to step S902, and the CPU 202 determines whether to restart the printing apparatus 100 or to execute the collective reflection processing by referencing the method for reflecting the setting item corresponding to the changed setting. In this determination, if the message and the button on the screen shown in FIG. 10A, for example, are displayed, it is determined to execute the collective reflection processing, and if the message and the button shown in FIG. 10B are displayed, it is determined to perform a restart. However, the setting type list 504 may be referenced when a setting is changed, and how a changed setting is to be reflected may be determined depending on the subject setting item, like the aforementioned changed value determination unit 505.

In the case where the CPU 202 determines that a restart is needed in step S902, the process proceeds to step S906, the CPU 202 restarts the printing apparatus 100, and the process ends. The restart performed in step S906 may be automatically performed in accordance with the determination result in step S902, or may be performed after querying the user if a restart may be performed.

On the other hand, in the case where the CPU 202 determines that the collective reflection processing is needed in step S902, the process proceeds to step S903, and the CPU 202 notifies applications that require the collective reflection processing. Next, the process proceeds to step S904, and the CPU 202 clears the change notification message and the setting reflection button from the operation screen displayed on the operation panel 211. Next, the process proceeds to step S905, and the applications that have received an event notification that the setting reflection button has been pressed start reflection processing while the applications synchronize with each other in the same manner as at the startup.

According to Embodiment 1, when performing the processing for collectively reflecting settings, the processing for reflecting the settings is started while the applications synchronize with each other, and therefore the reflection processing can be executed without mismatch of the behaviors, redundant processing, or the like, occurring due to the processing order of the applications.

### Embodiment 2

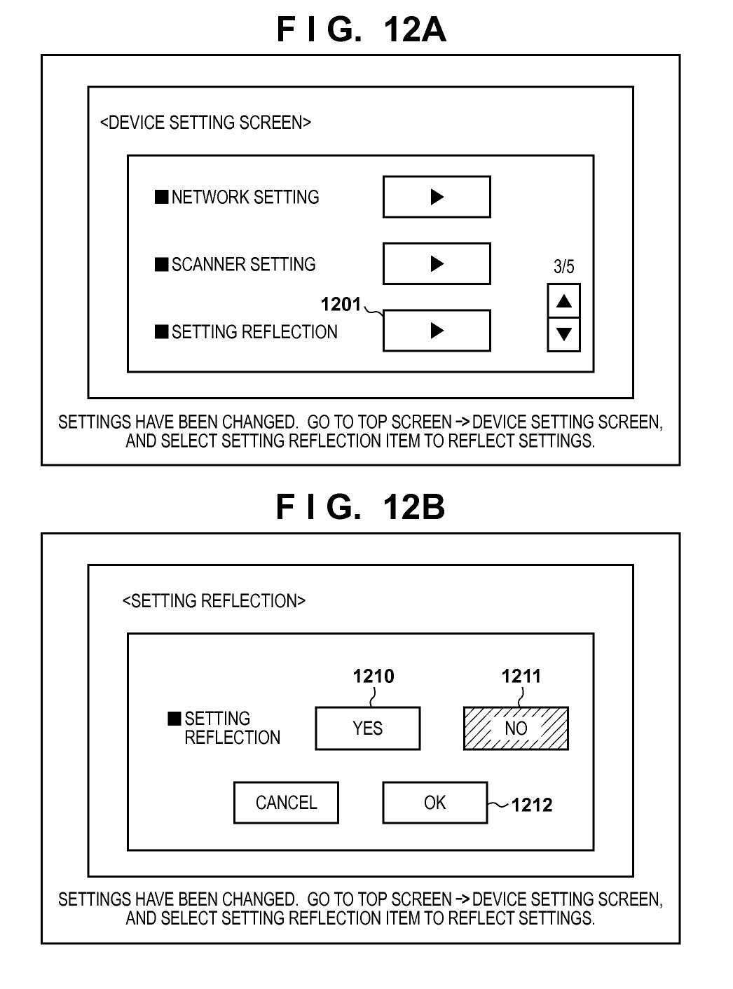

FIG. 12A and FIG. 12B are views showing examples of operation screens, which are displayed on the operation panel 211 of the printing apparatus 100 according to Embodiment 2 of the present invention, for issuing an instruction to reflect settings.

Embodiment 1 above has a configuration in which the setting reflection button is displayed on all operation screens and all function screens until settings are reflected after being changed, and a certain screen resource is needed to display it on all the screens. Therefore, in Embodiment 2, a message for reflecting settings is prepared as a setting item. This message describes how to transition to the setting screen for reflecting settings and perform an operation on the setting screen. Thus, the user can reflect settings in applications via the setting screen by making a transition to the setting screen through an operation in accordance with the message.

In this way, Embodiment 2 does not allow the user to select the operation to reflect the settings from any screen, but enables the screen resource to be saved, since it requires only addition of the aforementioned message to the function screens and the operation screens. The printing apparatus 100 and the network configuration according to Embodiment 2 are the same as in Embodiment 1 above, and thus the descriptions thereof are omitted.

FIG. 12A is a device setting screen for reflecting settings, and when the user selects an item 1201 for reflecting the settings on this screen, a transition to the screen for reflecting the settings shown in FIG. 12B is made.

In the case of executing the processing for reflecting settings on the screen of FIG. 12B, the user selects a “YES” button 1210 for reflecting settings and presses an OK button 1212. Conversely, in the case of not executing the processing for reflecting settings, the user selects a “NO” button 1211 for not reflecting settings and presses the OK button 1212.

In Embodiment 2, unlike Embodiment 1, the setting reflection button is not displayed on all screens, but the message to prompt the user to reflect settings is displayed on all screens as shown in FIG. 12A and FIG. 12B. At this time, the wording of the message to prompt the user to reflect settings is such that the paths to the locations of items whose settings are to be reflected are shown. This message indicates the fact that the settings have been changed, how to transition to the device setting screen for reflecting the settings, and which item is to be selected on the device setting screen. This message is cleared when an operation to reflect the settings is performed, in the same manner as in Embodiment 1 above.

The message to prompt the user to reflect the settings and the button on the setting reflection screen in Embodiment 2 may be displayed on the operation screen, or may be unshaded to be displayed thereon, at the time when the processing for reflecting the settings is needed.

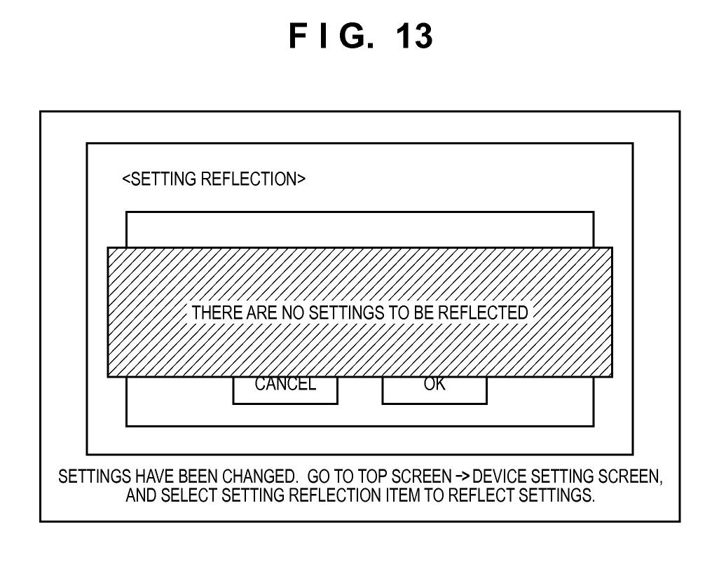

On the other hand, in the case where the aforementioned message or the like is always displayed so as to be selectable, the setting reflection button may possibly be pressed even though the user has not changed settings. In such a case, the operation determination unit 543 determines the presence or absence of changed settings, and in the case where it is determined that there are no changed settings and reflection is impossible, the operation determination unit 543 displays a screen notifying the user that there is no need for the processing for reflecting settings, as shown in FIG. 13.

FIG. 13 is a view showing an example of a screen to be displayed in the case where there are no changed settings to be reflected, when an instruction to reflect settings is issued via the screen of Embodiment 2.

In FIG. 13, a pop-up message “There are no settings to be reflected” indicating that there are no setting changes to be reflected is displayed.

According to Embodiment 2, although the user cannot issue an instruction to reflect or not reflect settings from any screen, it is possible to save the screen resource since only the addition of the aforementioned message on the function screens and the operation screens is needed.

### Embodiment 3

In Embodiments 1 and 2 described above, the setting control unit 501 holds the setting type list 504 as shown in FIG. 7 in advance. The setting type list 504 is programmed in advance in the HDD 214 or the ROM 204. In the case of such an embodiment, when a new application is added to the printing apparatus 100, a program corresponding to the setting control unit 501 needs to be added, and decreases the extensibility.

Therefore, in Embodiment 3, each application is provided with a registration processing unit that registers the type of setting items associated with the application in the setting control unit 501 at the time of startup. The registration processing unit of the application registers whether the setting items managed by the application are to be immediately reflected, reflected by a collective operation, or reflected by a restart in the setting control unit 501. The setting control unit 501 that has received this registration updates the setting type list 504 in accordance with the registered content. The printing apparatus 100 and the network configuration according to Embodiment 3 are the same as in Embodiment 1 above, and thus the descriptions thereof are omitted.

According to Embodiment 3, addition of a new application to the printing apparatus 100 can be dealt with without changing the setting control unit 501, that is, without changing the programs of the CPU, and therefore an apparatus with high extensibility can be obtained.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-119108 filed on Jun. 9, 2014, which is hereby incorporated by reference herein in its entirety.

What is claimed is:

1. An information processing apparatus having a first-type setting that does not require an additional user operation for reflecting a setting change in the information processing apparatus, a second-type setting that requires the additional user operation for reflecting a setting change in the information processing apparatus and does not require restarting the information processing apparatus, and a third-type setting that requires both the additional user operation and restarting the information processing apparatus for reflecting a setting change in the information processing apparatus, the information processing apparatus comprising:
a determination unit configured to determine, in a case where a setting of the information processing apparatus is changed by a user, whether or not the additional user operation is required for reflecting the setting change in the information processing apparatus;
a display unit configured to display a reflection button that allows the user to issue an instruction to reflect the setting change in the information processing apparatus, in a case where the determination unit determined that the additional operation is required;
a reflection unit configured to reflect the setting change in the information processing apparatus when the reflection button is operated by the user; and
a notification unit configured to notify the user that restarting the information processing apparatus is required, in a case where the setting changed by the user is the third-type setting, wherein
the determination unit determines that the additional operation is not required in a case where the setting changed by the user is the first-type setting,
the determination unit determines that the additional operation is required in a case where the setting changed by the user is the second-type setting or the third-type setting,
in a case where the determination unit determined that the additional operation is not required, the reflection unit reflects the setting change in the information processing apparatus without the display unit displaying the reflection button,
in a case where the reflection button is operated by the user, and the setting changed by the user is the second-type setting, the reflection unit reflects the setting change in the information processing apparatus without restarting the information processing apparatus,
in a case where the reflection button is operated by the user, and the setting changed by the user is the third-type setting, the reflection unit reflects the setting change in the information processing apparatus by restarting the information processing apparatus, and
the reflection button is a button for collectively reflecting a plurality of setting changes in the information processing apparatus.

2. The information processing apparatus according to claim 1, wherein the reflection button displayed in the case where the setting changed by the user is the second-type setting and the reflection button displayed in the case where the setting changed by the user is the third-type setting are buttons having a common name.

3. The information processing apparatus according to claim 1, wherein in a case where a plurality of settings changed by the user include both the second-type setting and the third-type setting, the notification unit notifies the user that restarting the information processing apparatus is required.

4. The information processing apparatus according to claim 1, wherein the information processing apparatus is a printing apparatus capable of executing printing.

5. A method for controlling an information processing apparatus having a first-type setting that does not require an additional user operation for reflecting a setting change in the information processing apparatus, a second-type setting that requires the additional user operation for reflecting a setting change in the information processing apparatus and does not require restarting the information processing apparatus, and a third-type setting that requires both the additional user operation and restarting the information processing apparatus for reflecting a setting change in the information processing apparatus, the method comprising:
determining, in a case where a setting of the information processing apparatus is changed by a user, whether or not the additional user operation is required for reflecting the setting change in the information processing apparatus;
displaying, on a display unit, a reflection button that allows the user to issue an instruction to reflect the setting change in the information processing apparatus, in a case where it is determined in the determination step that the additional operation is required;
reflecting the setting change in the information processing apparatus when the reflection button is operated by the user; and
notifying the user that restarting the information processing apparatus is required, in a case where the setting changed by the user is the third-type setting, wherein
it is determined in the determination step that the additional operation is not required in a case where the setting changed by the user is the first-type setting,
it is determined in the determination step that the additional operation is required in a case where the setting changed by the user is the second-type setting or the third-type setting,
in a case where it is determined in the determination step that the additional operation is not required, the setting change is reflected in the information processing apparatus in the reflection step without the display unit displaying the reflection button,
in a case where the reflection button is operated by the user, and the setting changed by the user is the second-type setting, the setting change is reflected in the information processing apparatus in the reflection step without restarting the information processing apparatus,
in a case where the reflection button is operated by the user, and the setting changed by the user is the third-type setting, the setting change is reflected in the information processing apparatus in the reflection step by restarting the information processing apparatus, and
the reflection button is a button for collectively reflecting a plurality of setting changes in the information processing apparatus.

6. A non-transitory computer-readable storage medium storing a computer program for causing a computer to execute a method for controlling an information processing apparatus having a first-type setting that does not require an additional user operation for reflecting a setting change in the information processing apparatus, a second-type setting that requires the additional user operation for reflecting a setting change in the information processing apparatus and does not require restarting the information processing apparatus, and a third-type setting that requires both the additional user operation and restarting the information processing apparatus for reflecting a setting change in the information processing apparatus, the program comprising:
determining, in a case where a setting of the information processing apparatus is changed by a user, whether or not the additional user operation is required for reflecting the setting change in the information processing apparatus;
displaying, on a display unit, a reflection button that allows the user to issue an instruction to reflect the setting change in the information processing apparatus, in a case where it is determined in the determination step that the additional operation is required;
reflecting the setting change in the information processing apparatus when the reflection button is operated by the user; and
notifying the user that restarting the information processing apparatus is required in a case where the setting changed by the user is the third-type setting, wherein
it is determined in the determination step that the additional operation is not required in a case where the setting changed by the user is the first-type setting,
it is determined in the determination step that the additional operation is required in a case where the setting changed by the user is the second-type setting or the third-type setting,
in a case where it is determined in the determination step that the additional operation is not required, the setting change is reflected in the information processing apparatus in the reflection step without the display unit displaying the reflection button,
in a case where the reflection button is operated by the user, and the setting changed by the user is the second-type setting, the setting change is reflected in the information processing apparatus in the reflection step without restarting the information processing apparatus,
in a case where the reflection button is operated by the user, and the setting changed by the user is the third-type setting, the setting change is reflected in the information processing apparatus in the reflection step by restarting the information processing apparatus, and
the reflection button is a button for collectively reflecting a plurality of setting changes in the information processing apparatus.
